(19) United States
(12) Patent Application Publication
(10) Pub. No.: US 2006/0153409 A1
(43) Pub. Date: Jul. 13, 2006

(54) Structure of a pair of glasses

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 11/030,992

(22) Filed: Jan. 10, 2005

(51) Int. Cl. H04R 5/02; H04R 9/06

(52) U.S. Cl. 381/333; 381/301

(57) ABSTRACT

An improved structure of a pair of glasses is disclosed. The pair of glasses is coupled with an audio-visual recording/showing device, and a pair of earpieces is coupled with a pair of earphones directly or through a direction changing connector. Accordingly, the audio-visual recording/showing device and the earphones are carried synchronously to enjoy the music stored therein when the glasses are worn, and the audio-visual recording/showing device is mounted in a position closest to the ear to avoid the problem of winding earphone wires. Moreover, by use of the earpieces or the direction changing connector, the glasses can be rotated upwardly in 90 degrees to form a beautiful hair hoop on the user's head.

### FIELD OF THE INVENTION

The present invention relates to an improved structure of a pair of glasses for synchronous utilization of the glasses and an audio-visual recording/showing device so as to reduce distance between user's ear and audio-visual recording/showing device and avoid the problem of winding earphone wires, wherein this improved structure is suitable to a pair of glasses, a hair hoop, or the like.

### BACKGROUND OF THE INVENTION

Modern people wear various glasses in accordance with requirements of various occasions. For instance, glasses for nearsightedness or farsightedness are applied to reading and working, and sunglasses and so forth are applied to outdoors or sporting event. Accordingly, the glasses become a necessary part of people's daily life.

During the commute time, it can be seen that many travelers in the public transportation utilize Walkmans to achieve the purposes of learning and entertainment. Tape Walkman and CD Walkman are previously utilized. However, users always complain that replacing operation of tapes or compact discs are indispensable to these two kinds of Walkmans, and they have large size and heavy weight. Consequently, a new generation MP3 player has been made in view of the drawbacks of the aforementioned Tape Walkman and CD Walkman.

The MP3 player, which has smaller dimension and lighter weight, is widely adopted by young people since it is not necessary for them to replace compact discs or tapes. It can be seen that almost every day student carries one MP3 player (voice player) by use of a necklace to hang it on the neck so as to listen to digital music or voice stored therein through a pair of wired earphones. However, interference from the earphone wires of the wired earphones still cannot be avoided even through this voice player has been improved some drawbacks of the conventional Walkman.

In view of the aforementioned drawbacks of the conventional structure, the present inventor has been made diligent studies with a quiet mind to provide an improved structure of a pair of glasses that integrates daily supplies, learning articles, and recreation articles with one another. This improved structure of the glasses is provided for the public in accordance with motivations of the present invention.

### SUMMARY OF THE INVENTION

The main object of the present invention is to provide an improved structure of a pair of glasses, which enables the user to carry the audio-visual recording/showing apparatus when he wears the glasses. Besides, the audio-visual recording/showing apparatus is mounted in a position closest to the ear so as to prevent from the winding earphone wires.

Another object of the present invention is to provide an improved structure of a pair of glasses for synchronous utilization of the glasses and the audio-visual recording/showing device. When the pair of glasses is not employed, the dual-purpose glasses can be rotated upwardly to the top of the user's head to form a beautiful hair hoop.

The still another purpose of the present invention is to provide an improved structure of a pair of glasses such that the glasses lenses of the glasses can be replaced in accordance with various occasions, and the glasses and the audio-visual recording/showing device can be detached from one another for separate utilization.

According to the aforementioned purposes of the present invention, an improved structure of a pair of glasses is provided. This pair of glasses is coupled with an audio-visual recording/showing device, and a pair of earpieces of the glasses is coupled with a pair of earphones directly or through a direction changing connector. Accordingly, the audio-visual recording/showing device and the earphones are carried synchronously to enjoy the music stored therein when this pair of glasses is worn, and the audio-visual recording/showing device is mounted in a position closest to the ear to avoid the problem of winding earphone wires. Moreover, by use of the entire earpieces or the direction changing connector, the glasses can be rotated upwardly in 90 degrees to form a beautiful hair hoop on the user's head.

The other features and preferred embodiments of the present invention will now be further described with reference to the accompanying drawings.

### BRIEF DESCRIPTION OF THE DRAWINGS

FIG. 1 is an elevational view showing outward appearance of a preferred embodiment of the present invention.

FIG. 2 is a decomposed view showing devices of the preferred embodiment of the present invention.

FIG. 3 is a schematic view showing usage of the preferred embodiment of the present invention.

FIG. 4 and FIG. 5 show the applicable examples for coupling the earphones with the earpieces in accordance with the preferred embodiment of the present invention.

FIG. 6 is a plan view showing a second preferred embodiment of the present invention.

FIG. 7 is a schematic diagram, which shows that the audio-visual recording/showing device of FIG. 6 is employed separately.

### DETAILED DESCRIPTION OF THE PREFERRED EMBODIMENT

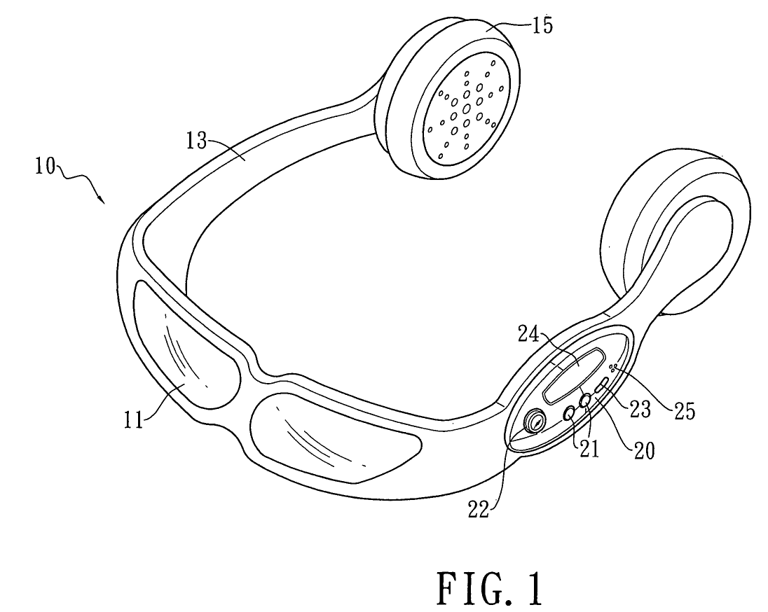

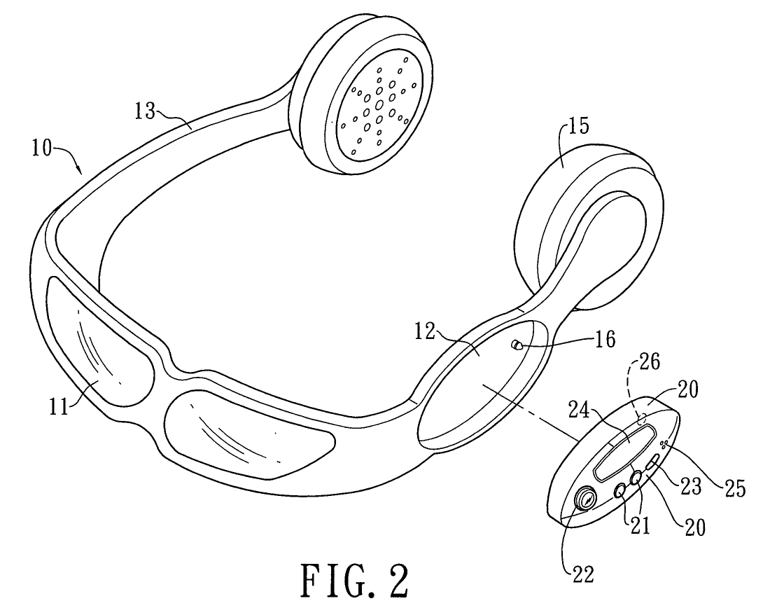

Referring to FIG. 1 and FIG. 2, an improved structure of the present invention comprises a pair of glasses 10 having two detachable and replaceable glasses lenses 11. The replacing operation of glasses lenses 11 may be performed by way of a magnetic fixing method, an embedding fixing method, a bolting fixing method, or a screwing fixing method. The framework of the glasses 10 comprises a trench 12 inside which an earphone plug 16 for inserting into and coupling with an audio-visual recording/showing device 20 is mounted. The audio-visual recording/showing device 20 comprises several function keys 21, a camera lens 22, an identifier 23, a USB connector (not shown), a monitor 24, a microphone 25, and an earphone jack 26 mounted thereon. Moreover, a Bluetooth chip and an automatic switching switch are mounted inside this audio-visual recording/showing device 20. Furthermore, each distal end of two earpieces 13 of the glasses 10 is coupled with an ear-covering type earphone 15 directly.

The camera lens 22 is mounted on the audio-visual recording/showing device 20 in a proper position of the periphery of the glasses lens 11 of the glasses 10 to enable the camera lens 22 and the microphone 25 to record the scenery and/or sound seen and/or heard by the user synchronously. Accordingly, the user carries the audio-visual recording/showing device 20 simultaneously when he wears the glasses 10 to perform the routine motions. If this user is desired to enjoy music by use of the ear-covering type earphones 15 that mount on the distal ends of the earpieces 13, then he just need to turn on the switch of the audio-visual recording/showing device 20 and presses the function keys 21. The limitation caused by the earphone wires is avoided since the audio-visual recording/showing device 20 is directly placed in a position closest to the ear.

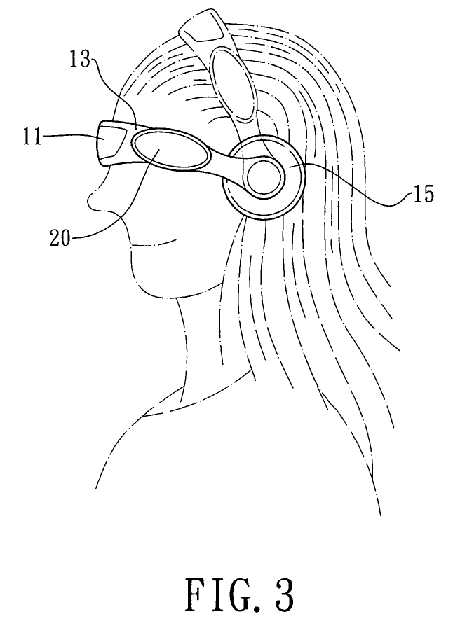

Furthermore, in accordance with the most common manner, if it is not desired to wear the glasses 10, the pair of glasses 10 is shifted from the user's nose to the top of his head. Therefore, the earpieces 13 are loosely hung on user's ears. In the present invention, the ear-covering type earphones 15 mounted on the distal ends of the earpieces 13 are adopted as rotation pivots such that the glasses 10 can be rotated upwardly in 90 degrees from the nose to the top of the head. Accordingly, the pair of glasses 10 is transformed into a beautiful hair hoop without need to shift the location of the ear-covering type earphones 15, as shown in FIG. 3.

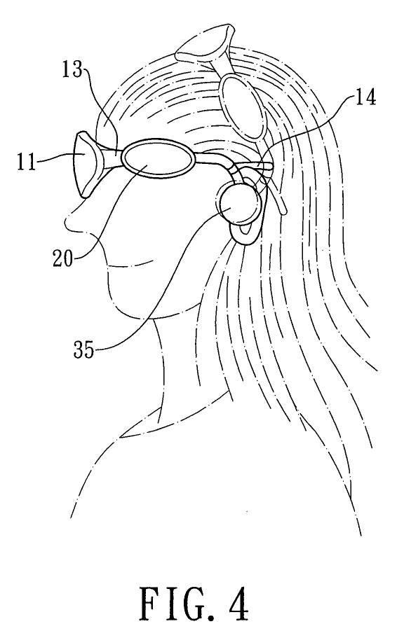

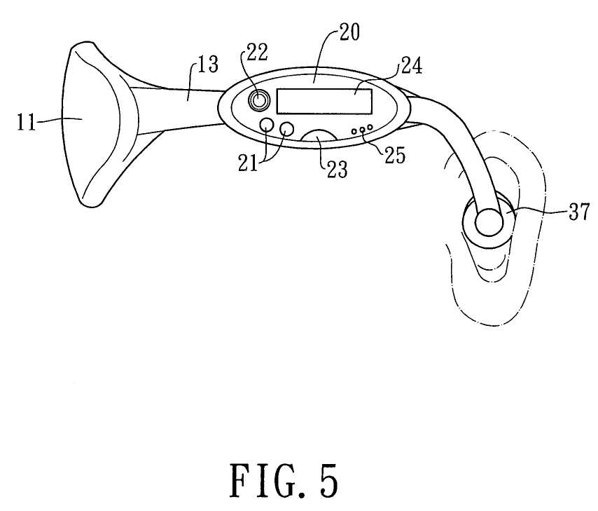

As shown in FIG. 4 and FIG. 5, the ear-covering type earphones 15 may be replaced by ear-hang type earphones 35 or in-ear type earphones 37. The ear-hang type earphones 35 are mounted on the distal ends of the earpieces 13 directly. Two lateral bars 14 are extended from bended portions of earpieces 13. When the glasses 10 are worn, the ear-hang type earphones 35 are exactly disposed on the outsides of earholes by hanging the lateral bars 14 on the ears to facilitate enjoying of music stored in the audio-visual recording/showing device 20. If it is desired to adopt the glasses 10 as a hair hoop, the glasses 10 are rotated upwardly and directly such that the lateral bars 14 are rotated downwardly and hung slantwise on the backsides of the ears. Moreover, the distal ends of the earpieces 13 may be designed to form the in-ear type earphones 37. When the glasses 10 are worn, the in-ear type earphones 37 on the distal ends of the earpieces 13 are plugged into the earholes directly. By use of the clipping force caused by the earpieces 13, the glasses 10 can be steadily mounted on the face to show the music stored in the audio-visual recording/showing device 20 through the in-ear type earphones 37. When this pair of glasses 10 is adopted as a hair hoop, the in-ear type earphones 37 are adopted as rotation pivots so as to rotate and shift the glasses 10 directly from the user's nose to the top of his head. Consequently, this pair of glasses 10 with practical function is transformed into a beautiful hair hoop without affecting the music-showing function of the audio-visual recording/showing device 20.

Moreover, the earpieces 13 may further comprise a direction changing connector to facilitate the upward rotation of the glasses 10. Accordingly, the ear-covering type earphones 15, the ear-hang type earphones 35, or the in-ear type earphones are not deviated from the ears no matter the pair of glasses 10 is adopted as glasses or hair hoop. Moreover, for the purpose of entrance control, the identifier 23, which is mounted inside the audio-visual recording/showing device 20, is a Radio Frequency Identification System to enable a card reader to read the RFID code stored therein. Furthermore, because of the Bluetooth chip that mounts inside the audio-visual recording/showing device 20, the automatic switching switch will switch the status of showing music to the status of answering phone call if there is an incoming call for the user's mobile phone. Accordingly, the user is able to answer the phone call and make a conversation directly by use of the microphone 25 of the audio-visual recording/showing device 20 without stopping the working in progress to find out the mobile phone.

Moreover, the audio-visual recording/showing device 20 comprises a USB connector or a wireless transmission device (not shown), which is connected to a computer. Besides, the camera lens 22 further cooperates with a palm-size monitor, wherein the captured data are transmitted to the palm-size monitor through the wireless transmission device to facilitate the user to watch the data immediately, or a projection method may be utilized directly to project images to the glasses lenses. In addition, a thin-film LCD eyeshade may be utilized to achieve the purpose of watching the captured data immediately. Therefore, if the user desires to watch the captured images, it is not necessary for him to come back to the room where he disposes the computer and take off the audio-visual recording/showing device 20 for connecting the audio-visual recording/showing device 20 with the computer. Moreover, a LED light for indicating the recording status may be mounted on the earpieces of the glasses 10 in a position where the user can see. Alternatively, the recording status may be projected on the glasses lenses or the thin-film LCD eyeshade to enable the user to recognize the recording status. In addition, the palm-size monitor may comprise a position system selected from a group consisting of GPS, CDMA, GSM, and PHS for providing with an advanced tracking function. The identifier 23, the camera lens 22, the Bluetooth chip, the automatic switching switch, the wireless transmission device, and the memory card slot mounted on the audio-visual recording/showing device 20 are designed in modulation to facilitate the user to assemble and utilize thereof.

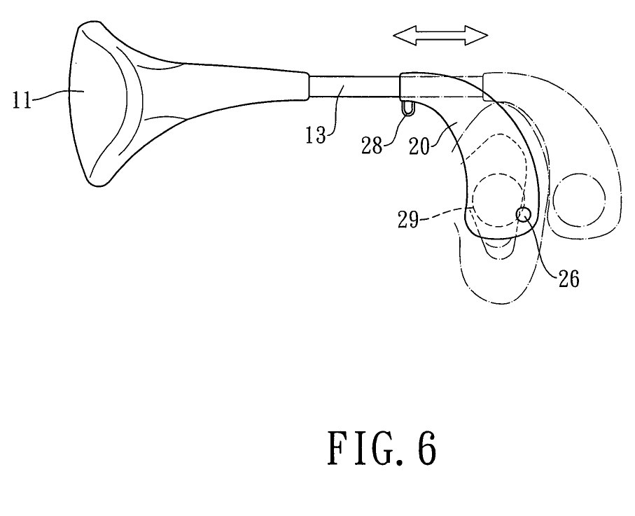

Referring to FIG. 6, a second preferred embodiment of the preset invention is shown. In this embodiment, the earpieces 13 of the glasses 19 are designed to be the telescopic earpieces, and one distal end of the earpieces 13 is coupled to the audio-visual recording/showing device 20 having a curved shape conformal to the distal end of the earpiece 13. A connection part for connecting to the earpiece 13 and a hook 28 are mounted on the audio-visual recording/showing device 20, and a cone shape speaker 29 is mounted on the inner side of the audio-visual recording/showing device 20. If only the pair of glasses 10 is utilized, the earpieces 13 of the present invention are stretched out for hanging on the ears in the same manner as the general glasses. If the user wants to listen to music, he just needs to shrink the length of the earpieces 13 and plug the speaker 29, which is protruded from the audio-visual recording/showing device 20, into the earholes directly. By use of the audio-visual recording/showing device 20 plugged into the earholes and the clipping force caused by the earpieces, the pair of glasses 10 is firmed. Consequently, the audio-visual recording/showing device 20 is carried simultaneously when the pair of glasses 10 is worn.

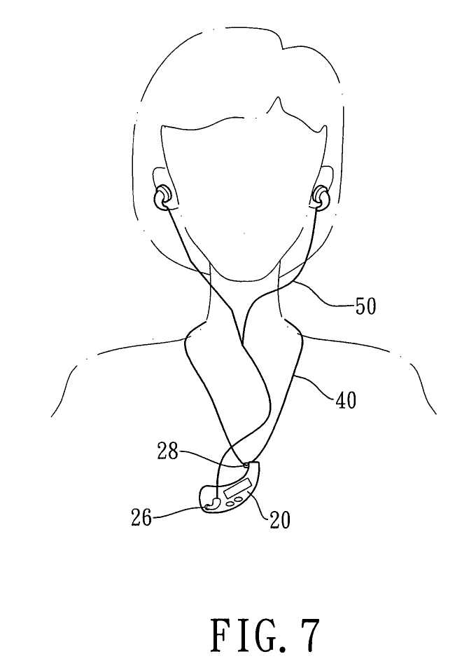

In addition, as shown in FIG. 7, the audio-visual recording/showing device 20 of the present invention is designed in modulation. Accordingly, the glasses 10 may be detached from the glasses 10 for separate use. By use of a necklace 40 that penetrates through the hook 28, the detached audio-visual recording/showing device 20 can be hung on the neck of the user. Next, a pair of earphones 50 is plugged into the earphone jack 26 of the audio-visual recording/showing device 20. Accordingly, the glasses 10 and the audio-visual recording/showing device 20 can be utilized separately.

For the forgoing description, it is apparent that the apparatus of the present invention comprises the following advantages.

1. The audio-visual recording/showing device and the glasses are integrated into unity. Accordingly, when the user wears the glasses, he also carries the audio-visual recording/showing device. Moreover, the limitation caused by the earphone wires is prevented since the audio-visual recording/showing device is mounted directly in a position closest to the ear.

2. When this pair of glasses with practicability is not utilized, it can be rotated upwardly to the top of the user's head to form a beautiful hair hoop. Accordingly, the earphones, which are coupled with the earpieces, are not deviated from the ears no matter the pair of glasses is adopted as the glasses or the hair hoop.

3. Because of the Bluetooth chip that mounts inside the audio-visual recording/showing device, the user is able to answer the phone call and make a conversation directly without stopping the working in progress to find out the mobile phone and detach the earphones.

4. The user is capable of making selection freely according to his own requirement since the camera lens, the wireless transmission device, the identifier, the Bluetooth chip, etc are designed in modulation,

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention is able to achieve the expected purpose of the present invention by providing an improved structure of a pair of glasses. The application having practicability is therefore submitted for a patent.

What the invention claimed is:

1. An improved structure of a pair of glasses comprising:
said pair of glasses;
an audio-visual recording/showing device coupled to said pair of glasses for storing audio-visual data; and
a pair of earphones coupled with a pair of earpieces of said pair of glasses, thereby
said audio-visual recording/showing device is carried simultaneously when said pair of glasses is worn, and said audio-visual recording/showing device is mounted in a position closest to the ear to avoid the problem of winding earphone wires, wherein when said pair of glasses is not utilized, it can be rotated upwardly to the top of user's head to form a beautiful hair hoop.

2. The improved structure of a pair of glasses of claim 1, wherein a trench is formed on one of said pair of earpieces for holding said audio-visual recording/showing device.

3. The improved structure of a pair of glasses of claim 2, wherein an earphone jack is mounted in said trench.

4. The improved structure of a pair of glasses of claim 3, wherein said pair of earphones is a pair of ear-covering type earphones, a pair of ear-hang type earphones, or a pair of in-ear type earphones, and said pair of earphones is connected to said earphone jack mounted in said trench.

5. The improved structure of a pair of glasses of claim 4, wherein two lateral bars are protruded from said pair of earpieces for hanging on the ears when said pair of ear-hang type earphones is mounted on distal ends of said pair of earpieces.

6. The improved structure of a pair of glasses of claim 1, wherein said pair of earphones is a pair of ear-covering type earphones, a pair of ear-hang type earphones, or a pair of in-ear type earphones, and said pair of earphones is connected to an earphone jack, which is mounted in a trench formed on one of said pair of earpieces.

7. The improved structure of a pair of glasses of claim 1, wherein two replaceable glasses lenses are mounted on said pair of glasses and said pair of earpieces is designed to be a pair of telescopic earpieces.

8. The improved structure of a pair of glasses of claim 1, wherein said audio-visual recording/showing device is designed in modulation.

9. The improved structure of a pair of glasses of claim 8, wherein said audio-visual recording/showing device comprises an identifier, a camera lens, a memory card slot, a Bluetooth chip, and an automatic switching switch, or a wireless transmission device mounted thereon and designed in modulation to enable the user to make a selection freely.

10. The improved structure of a said pair of glasses of claim 9, wherein said modular camera lens is mounted on periphery of two glasses lenses of said pair of glasses to enable said audio-visual recording/showing device to record scenery and/or sound seen and/or heard by the user.

11. The improved structure of a pair of glasses of claim 9, wherein said camera lens of said audio-visual recording/showing device further cooperates with a palm-size monitor, or a projection method may be utilized to project images to two glasses lenses of said pair of glasses.

12. The improved structure of a pair of glasses of claim 11, wherein said palm-size monitor comprises a position system selected from a group consisting of GPS, CDMA, GSM, and PHS.

13. The improved structure of a pair of glasses of claim 1, wherein said camera lens of said audio-visual recording/showing device further cooperates with a palm-size monitor, or a projection method may be utilized to project images to two glasses lenses of said pair of glasses.

14. The improved structure of a pair of glasses of claim 13, wherein said palm-size monitor comprises a position system selected from a group consisting of GPS, CDMA, GSM, and PHS.

15. The improved structure of a pair of glasses of claim 1, wherein said audio-visual recording/showing device can be detached form said pair of glasses for separate use and comprises a hook penetrated by a necklace for carry.
